(19) United States
(12) Patent Application Publication
(10) Pub. No.: US 2020/0092521 A1
(43) Pub. Date: Mar. 19, 2020

(54) PARKING ASSISTANCE APPARATUS, VEHICLE, PARKING ASSISTANCE METHOD, AND RECORDING MEDIUM

(71) Applicant: HONDA MOTOR CO., LTD., Tokyo (JP)

(72) Inventors: Miki TSUJINO, WAKO-SHI (JP); Masashi YOSHIFUKU, WAKO-SHI (JP)

(21) Appl. No.: 16/570,210

(22) Filed: Sep. 13, 2019

(30) Foreign Application Priority Data
Sep. 14, 2018 (JP) 2018-172840

(51) Int. Cl. H04N 7/18; B60R 1/00; H04N 5/225; G06F 3/14

(52) U.S. Cl. CPC H04N 7/183; B60R 1/00; H04N 5/2253; B62D 15/0285; B60R 2300/30; B60R 2300/607; B60R 2300/806; G06F 3/14

(57) ABSTRACT

A parking assistance apparatus displays, on a display unit disposed in a host vehicle, a taken image obtained by an imaging unit that images a surrounding of the host vehicle. The parking assistance apparatus includes a vehicle speed sensor that detects a vehicle speed of the host vehicle and a display control unit that displays a surrounding image obtained by the imaging unit on the display unit. The display control unit changes a display range of the surrounding image based on at least the detected vehicle speed of the host vehicle.

### CROSS-REFERENCE TO RELATED APPLICATION

This application is based upon and claims the benefit of priority from Japanese Patent Application No. 2018-172840 filed on Sep. 14, 2018, the contents of which are incorporated herein by reference.

### BACKGROUND OF THE INVENTION

### Field of the Invention

The present invention relates to a parking assistance apparatus, a vehicle, a parking assistance method, and a non-transitory computer readable recording medium.

### Description of the Related Art

The task of the parking assistance apparatus disclosed in Japanese Laid-Open Patent Publication No. 2013-006548 is to provide a user with a bird's-eye picture in which a parking space is displayed on a display screen in real time even when a host vehicle moves.

To achieve this task, the parking assistance apparatus includes parking target position detection means that detects a parking target position in which a vehicle is parked from a first bird's-eye picture, viewpoint position determination means that determines a viewpoint position, rotation amount determination means that determines a rotation amount, view point conversion table creation means that creates a view point conversion table used to rotate the first bird's-eye picture based on the viewpoint position and the rotation amount, and second bird's-eye picture generation means that generates a second bird's-eye picture from the first bird's-eye picture based on the view point conversion table.

The task of the parking assistance apparatus disclosed in Japanese Laid-Open Patent Publication No. 2015-074259 is to enable the driver to grasp the surrounding of the host vehicle more easily.

To achieve this task, the display control means of the parking assistance apparatus displays a bird's-eye image without displaying any surrounding images when the host vehicle is stopped during target parking position setting control, displays a bird's-eye image without displaying any surrounding images or displays a bird's-eye image and a front image when the host vehicle is moving forward during target parking position setting control, or displays both a bird's-eye image and a rear image when the host vehicle is moving rearward during target parking position setting control.

### SUMMARY OF THE INVENTION

However, in the parking assistance apparatuses disclosed in Japanese Laid-Open Patent Publication No. 2013-006548 and Japanese Laid-Open Patent Publication No. 2015-074259, there are no descriptions about effects of the vehicle speed of the host vehicle on the display range in surrounding monitoring by the occupant.

An object of the present invention is to provide a parking assistance apparatus, a vehicle, a parking assistance method, and a non-transitory computer readable recording medium capable of improving surrounding monitoring by the driver by displaying an appropriate range of the surrounding of the host vehicle according to at least the vehicle speed.

According to an aspect of the present invention, there is provided a parking assistance apparatus that displays, on a display unit disposed in a host vehicle, a taken image obtained by an imaging unit that images a surrounding of the host vehicle, the parking assistance apparatus including a unit configured to detect a speed of the host vehicle, and a display control unit configured to display a surrounding image obtained by the imaging unit on the display unit, wherein the display control unit is configured to change a display range of the surrounding image based on at least the detected speed of the host vehicle.

According to another aspect of the present invention, there is provided a vehicle including the parking assistance apparatus described above.

According to still another aspect of the present invention, there is provided a parking assistance method that outputs, to display unit disposed in a host vehicle, a taken image obtained by an imaging unit that images a surrounding of the host vehicle, the parking assistance method including a step of detecting a speed of the host vehicle, and a display control step of displaying a surrounding image obtained by the imaging unit on the display unit, wherein the display control step changes a display range of the surrounding image based on at least the detected speed of the host vehicle.

According to yet another aspect of the present invention, there is provided a non-transitory computer readable recording medium in which a program is stored for executing in a computer: a step of outputting, to a display unit disposed in a host vehicle, a taken image obtained by an imaging unit that images a surrounding of the host vehicle; a step of detecting a speed of the host vehicle; a step of displaying a surrounding image obtained by the imaging unit on the display unit; and a step of changing a display range of the surrounding image based on at least the detected speed of the host vehicle.

According to the present invention, it is possible to provide a parking assistance apparatus, a vehicle, a parking assistance method, and a non-transitory computer readable recording medium capable of improving surrounding monitoring by the driver by displaying an appropriate range of the surrounding of the host vehicle according to at least the vehicle speed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a vehicle having a parking assistance apparatus according to an embodiment;

FIG. 2 shows an example of an operation input unit;

FIG. 3 shows an example of at least one possible parking position in which a host vehicle can be parked and an example of a target parking position;

FIG. 4 shows a first example of a display screen in the embodiment;

FIG. 5 shows a second example of the display screen in the embodiment;

FIG. 6 shows a third example of the display screen in the embodiment;

FIG. 7 shows a fourth example of the display screen in the embodiment;

FIG. 8 shows a fifth example of the display screen in the embodiment;

FIGS. 9A, 9B, and 9C are explanatory diagrams showing examples (forward movement) in which a display range of a surrounding image displayed in a bird's-eye image region is changed by a first method;

FIGS. 10A, 10B, and 10C are explanatory diagrams showing examples (rearward movement) in which the display range of the surrounding image displayed in the bird's-eye image region is changed by the first method;

FIG. 11A is an explanatory diagram showing an example (forward movement) in which a mask is applied and FIG. 11B is an explanatory diagram showing an example (rearward movement) in which a mask is applied;

FIGS. 12A, 12B, and 12C are explanatory diagrams showing examples (forward movement) in which the display range of the surrounding image displayed in the bird's-eye image region is changed by a second method;

FIGS. 13A, 13B, and 13C are explanatory diagrams showing examples (rearward movement) in which the display range of the surrounding image displayed in the bird's-eye image region is changed by the second method; and

FIG. 14 is a flowchart showing a process operation of the parking assistance apparatus according to the embodiment.

### DESCRIPTION OF THE PREFERRED EMBODIMENTS

A parking assistance apparatus, a vehicle, a parking assistance method, and a program according to the present invention will be described in detail below by using a preferable embodiment and referencing the attached drawings.

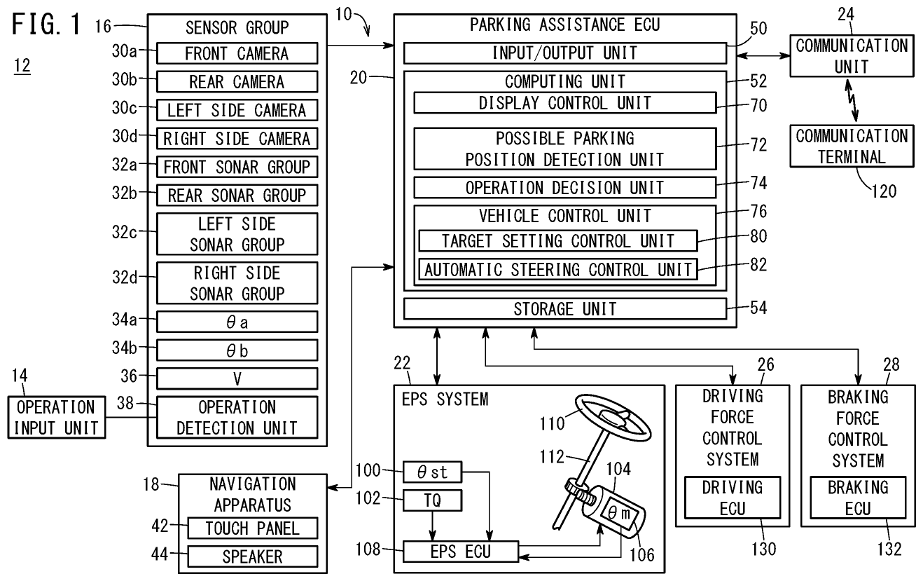

A parking assistance apparatus, a vehicle, a parking assistance method, and a program according to an embodiment will be described with reference to the drawings. FIG. 1 is a block diagram showing a vehicle 12 (for example, a host vehicle) having a parking assistance apparatus 10 according to the embodiment.

The parking assistance apparatus 10 according to the embodiment assists the parking of the vehicle 12 by performing automatic steering. That is, a steering 110 is automatically operated by the parking assistance apparatus 10. Although an accelerator pedal (not shown), a brake pedal (not shown), and an operation input unit 14 are operated by the user in the following example, the present invention is not limited to this example. For example, the accelerator pedal, the brake pedal, and the operation input unit 14 may be operated automatically.

As shown in FIG. 1, the parking assistance apparatus 10 includes a sensor group 16, a navigation apparatus 18, a parking assistance electronic control unit (parking assistance ECU) 20, an electric power steering system (EPS system) 22, and a communication unit 24. The parking assistance apparatus 10 further includes a driving force control system 26 and a braking force control system 28.

The sensor group 16 obtains various types of detection values used for parking assistance. The sensor group 16 includes a front camera 30a, a rear camera 30b, a left side camera 30c, and a right side camera 30d. The sensor group 16 further includes a front sonar group 32a, a rear sonar group 32b, a left side sonar group 32c, and a right side sonar group 32d. The sensor group 16 further includes wheel sensors 34a and 34b, a vehicle speed sensor 36, and an operation detection unit 38.

The front camera 30a, the rear camera 30b, the left side camera 30c, and the right side camera 30d output surrounding images obtained by imaging surroundings of the vehicle 12. The surrounding images taken by the front camera 30a, the rear camera 30b, the left side camera 30c, and the right side camera 30d are referred to as a front image, a rear image, a left side image, and a right side image, respectively. The side images include the left side image and the right side image.

The front sonar group 32a, the rear sonar group 32b, the left side sonar group 32c, and the right side sonar group 32d emit sound waves to the surroundings of the vehicle 12 and receive reflected sounds from other objects. The front sonar group 32a includes, for example, four sonars. The sonars included in the front sonar group 32a are provided diagonally forward left, forward left, forward right, and diagonally forward right of the vehicle 12. The rear sonar group 32b includes, for example, four sonars. The sonars included in the rear sonar group 32b are provided diagonally rearward left, rearward left, rearward right, and diagonally rearward right of the vehicle 12. The left side sonar group 32c includes, for example, two sonars. The sonars included in the left side sonar group 32c are provided forward on the left side and rearward on the left side of the vehicle 12. The right side sonar group 32d includes, for example, two sonars. The sonars included in the right side sonar group 32d are provided forward on the right side and rearward on the right side of the vehicle 12.

The wheel sensors 34a and 34b detect the rotation angles of wheels (not shown), respectively. The wheel sensors 34a and 34b may be angle sensors or may be displacement sensors. The wheel sensors 34a and 34b output detection pulses each time the wheels turn a predetermined angle. The detection pulses output from the wheel sensors 34a and 34b may be used to calculate the rotation angles of the wheels or the rotation speeds of the wheels. The movement distance of the vehicle 12 may be calculated based on the rotation angles of the wheels. The wheel sensor 34a detects a rotation angle θa of, for example, a left rear wheel. The wheel sensor 34b detects a rotation angle θb of, for example, a right rear wheel.

The vehicle speed sensor 36 detects the speed (that is, a vehicle speed V) of a vehicle body (not shown) of the vehicle 12 and outputs the detected vehicle speed V to the parking assistance ECU 20. The vehicle speed sensor 36 detects the vehicle speed V based on, for example, the rotation of a counter shaft of a transmission.

The operation detection unit 38 detects the operation performed by the user via the operation input unit 14 and outputs the detected operation to the parking assistance ECU 20. In the following example, the operation input unit 14 is a shift lever (select lever or selector) and the operation detection unit 38 is a shift position sensor. The operation detection unit 38 detects the shift position in the operation input unit 14 and outputs the detected shift position to the parking assistance ECU 20 or the like.

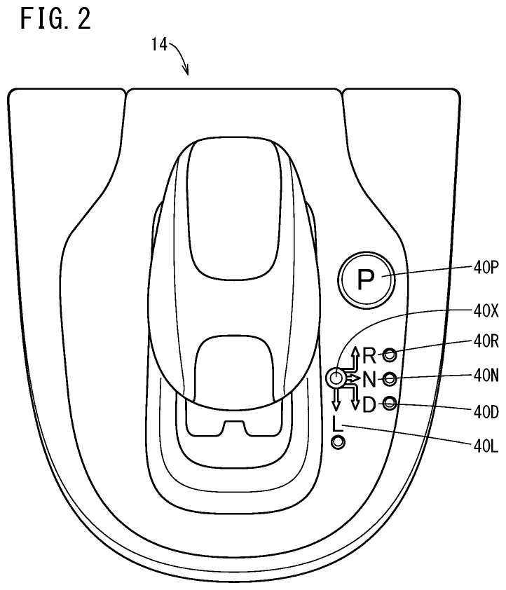

The operation input unit 14 may be used at least in switching between the forward movement and the rearward movement of the vehicle 12. FIG. 2 shows an example of the operation input unit 14. As described above, the operation input unit 14 is the shift lever. The operation input unit 14 has a shift position (first shift position), that is, a D range 40D, used to move the vehicle 12 forward. In addition, the operation input unit 14 further has a shift position (second shift position), that is, an R range 40R, used to move the vehicle 12 rearward. In addition, the operation input unit 14 further has an L range 40L and an N range 40N. In the vicinity of the operation input unit 14, a P button 40P used for parking is provided. The operation input unit 14 is configured so that an automatic return to a neutral position 40X is performed.

The navigation apparatus 18 detects the current position of the vehicle 12 using, for example, a global positioning system (GPS) and indicates the path to the destination to the user. The navigation apparatus 18 has a storage device (not shown) provided with a map information database.

The navigation apparatus 18 has a touch panel 42 and a speaker 44. The touch panel 42 can function as an input device and display device (display unit) of the parking assistance apparatus 10. The user can input a command concerning parking assistance via the touch panel 42. In addition, a screen concerning parking assistance can be displayed on the touch panel 42. A component other than the touch panel 42 may be used as an input device or a display device. In addition, audio assistance can be performed via the speaker 44 in parking assistance. The speaker 44 can function as a notification unit that notifies the occupant of the start of the movement of the vehicle 12 before the vehicle 12 starts to move to a target parking position 92.

The parking assistance ECU 20 includes an input/output unit 50, a computing unit 52, and a storage unit 54. The computing unit 52 may include, for example, a central processing unit (CPU). The computing unit 52 performs parking assistance by controlling individual units based on programs stored in the storage unit 54.

The computing unit 52 includes a display control unit 70, a possible parking position detection unit 72, an operation decision unit 74, and a vehicle control unit 76. The vehicle control unit 76 includes a target parking position setting control unit (referred to below as a target setting control unit 80) and an automatic steering control unit 82. The display control unit 70, the possible parking position detection unit 72, the operation decision unit 74, and the vehicle control unit 76 may be achieved by causing the computing unit 52 to execute programs stored in the storage unit 54.

The display control unit 70 changes the display ranges of surrounding images based on, for example, the decision result (forward movement or rearward movement) by the operation decision unit 74 and the detected speed (vehicle speed V) of the vehicle 12. This processing will be described later.

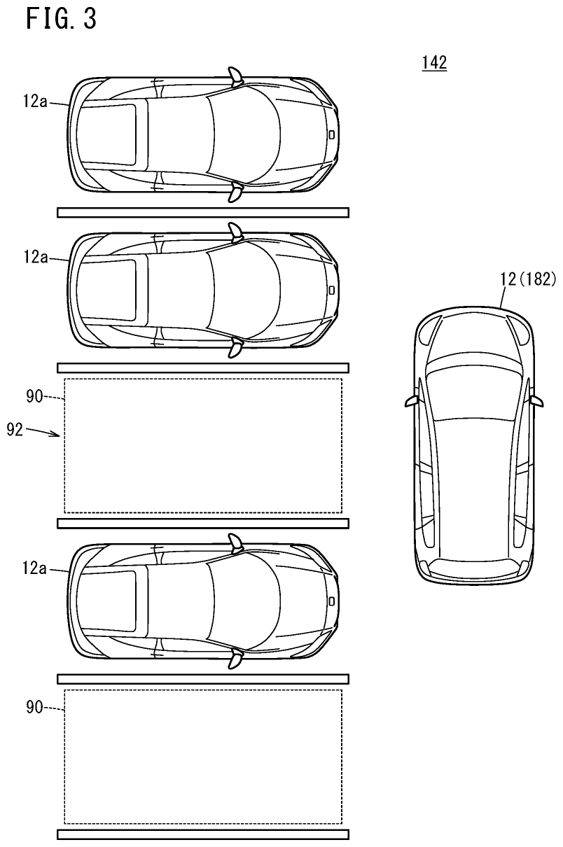

The possible parking position detection unit 72 detects at least one possible parking position 90 (see FIG. 3) at which the vehicle 12 can park. The possible parking position 90 detected by the possible parking position detection unit 72 (see FIG. 1) can be displayed on, for example, the touch panel 42 of the navigation apparatus 18.

FIG. 3 conceptually shows an example of a part of an image displayed on the display screen of the touch panel 42. As shown in FIG. 3, a bird's-eye image 142 containing an image (host vehicle image 182) of the vehicle (host vehicle) 12 may be displayed on the display screen of the touch panel 42. As shown in FIG. 3, for example, other vehicles 12a park in three parking spaces of five parking spaces. The other vehicles 12a do not park in two parking spaces of the five parking spaces.

The possible parking position detection unit 72 can detect the parking spaces in which the other vehicles 12a do not park as the possible parking positions 90. The bird's-eye image 142 described above can be generated by using, for example, the sensor group 16 described above as appropriate. The user can select the target parking position 92 from the possible parking positions 90 displayed on the touch panel 42. For example, the user can select the target parking position 92 by touching one of the possible parking positions 90 displayed on the touch panel 42. Although the target parking position 92 is selected by the user in the following example, the invention is not limited to this example. The target parking position 92 may be automatically selected by the vehicle control unit 76.

The operation decision unit 74 can decide the operation (such as, for example, forward movement or rearward movement) performed by the user via the operation input unit 14.

The target setting control unit 80 of the vehicle control unit 76 performs control for setting the target parking position 92 of the vehicle 12. Meanwhile, the automatic steering control unit 82 of the vehicle control unit 76 performs control for automatically operating the steering 110 so that the vehicle 12 reaches the target parking position 92, based on an operation instruction from the user after setting the target parking position 92. Automatic operation of the steering 110 is performed by causing the EPS system 22 to control an EPS motor 104. The display control unit 70 links the display range to the vehicle speed as described later from the start of vehicle control by the automatic steering control unit 82 of the vehicle control unit 76. That is, the display range is changed according to the detected vehicle speed V of the vehicle 12.

The EPS system 22 includes a steering angle sensor 100, a torque sensor 102, the EPS motor 104, a resolver 106, and an EPS electronic control unit (EPS ECU) 108.

The steering angle sensor 100 detects a steering angle θst of the steering 110. The torque sensor 102 detects a torque TQ applied to the steering 110.

The EPS motor 104 enables operation assistance of the steering 110 for the vehicle occupant and automatic steering at the time of parking assistance, by applying a driving force or a reaction force to a steering column 112 connected to the steering 110. The resolver 106 detects a rotation angle θm of the EPS motor 104.

The EPS ECU 108 controls the entire EPS system 22. The EPS ECU 108 includes an input-output unit (not shown), a computing unit (not shown), and a storage unit (not shown).

The communication unit (wireless communication unit) 24 enables wireless communication with a communication terminal 120 described later. The vehicle control unit 76 can communicate with the communication terminal 120 via the communication unit 24.

The driving force control system 26 has a driving ECU 130. The driving force control system 26 controls a driving force for the vehicle 12. The driving ECU 130 controls the driving force for the vehicle 12 by controlling an engine (not shown) and the like based on an operation of the accelerator pedal (not shown) by the user.

The braking force control system 28 has a braking ECU 132. The braking force control system 28 controls a braking force for the vehicle 12. The braking ECU 132 controls the braking force for the vehicle 12 by controlling a brake mechanism (not shown) and the like based on an operation of the brake pedal (not shown) by the user.

Here, the control operation, particularly changes in the display form of the display screen, of the parking assistance apparatus 10 according to the embodiment will be described.

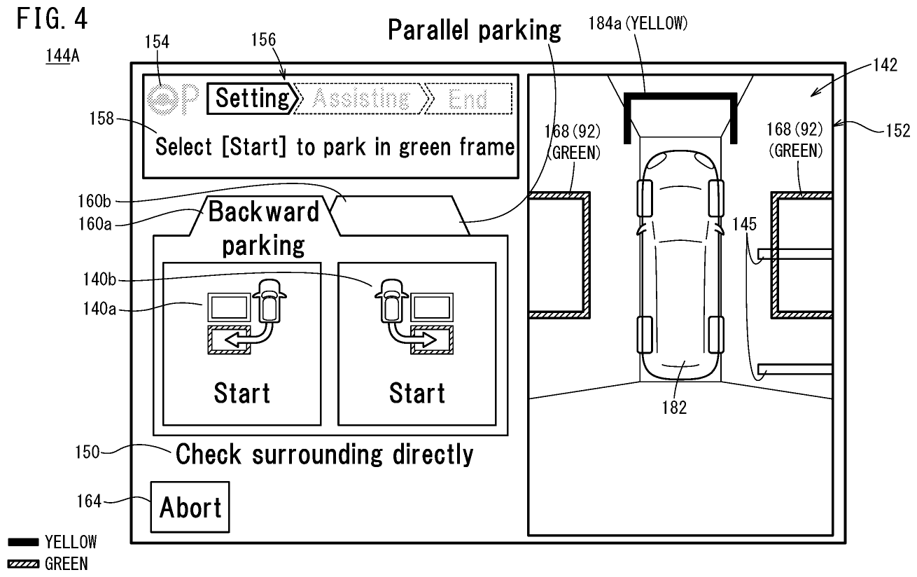

First, when parking assistance is started, the target setting control unit 80 of the vehicle control unit 76 starts a target setting process. At this time, as shown in FIG. 4, a first display screen 144A containing automatic steering start buttons 140a and 140b (also referred to below as start buttons 140a and 140b) and the bird's-eye image 142 is displayed.

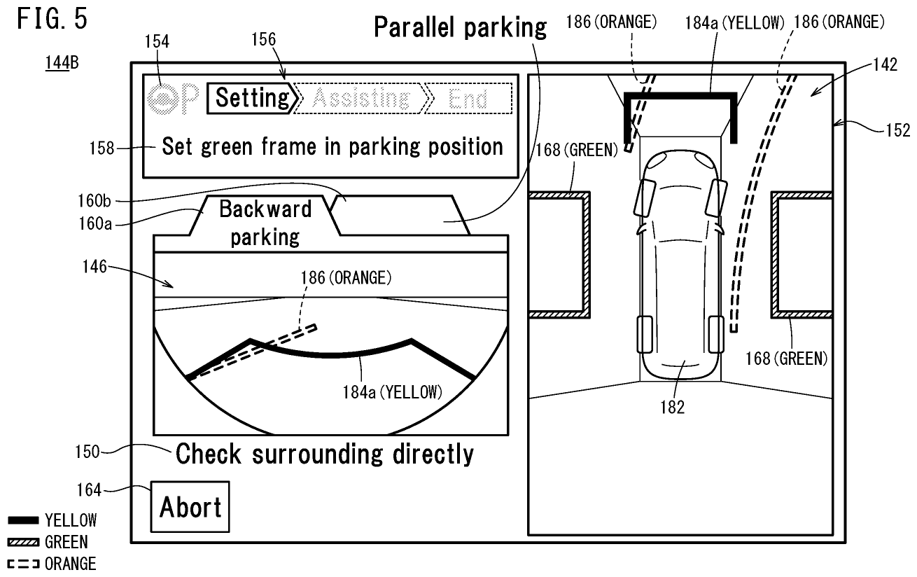

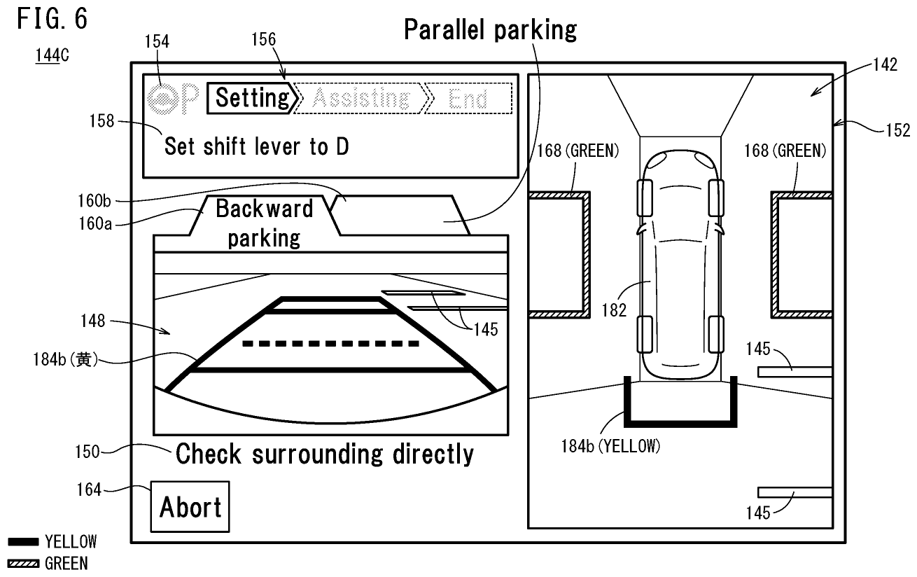

When the target setting process is being executed by the vehicle control unit 76, the display form is switched depending on whether the vehicle 12 is stopped, moving forward, or moving rearward. Specifically, if the vehicle 12 is stopped, as shown in FIG. 4, the parking assistance ECU 20 displays the first display screen 144A containing the start buttons 140a and 140b and the bird's-eye image 142. If the vehicle 12 is moving forward, as shown in FIG. 5, the parking assistance ECU 20 displays a second display screen 144B containing a front image region 146 and the bird's-eye image 142. In addition, if the vehicle 12 is moving rearward, as shown in FIG. 6, the parking assistance ECU 20 displays a third display screen 144C containing a rear image region 148 and the bird's-eye image 142. In addition, a bird's-eye image region 152 in FIG. 4 contains white lines 145 as a part of the bird's-eye image 142. The white lines 145 partition a parking space.

When, for example, the shift position is other than R (rearward movement) and the vehicle speed V is 0 km/h, it is decided that the vehicle 12 is stopped. It may be also decided that the vehicle 12 is stopped if the vehicle speed V indicates that the vehicle 12 is substantially stopped (for example, 0<V<5 km/h) even when the vehicle speed V is not 0 km/h.

In addition, when, for example, the shift position is other than R (rearward movement) and the vehicle speed V is more than 0 km/h, it is decided that the vehicle 12 is moving forward. When, for example, the shift position is R, it is decided that the vehicle 12 is moving rearward.

FIG. 4 shows an example of the first display screen 144A when the vehicle 12 is stopped in a target position setting process. The first display screen 144A contains a parking assistance mark 154 in an inactive state, a progress indication bar 156, an operation guidance message 158, parking type selection tabs 160a and 160b each having the automatic steering start buttons 140a and 140b, an abort button 164, and the like in addition to an attention attracting message 150 and the bird's-eye image region 152.

The parking assistance mark 154 is active and displayed densely while automatic steering control is being executed, or is inactive and displayed dimly while target parking position setting control is being executed so as to indicate the progress of parking assistance.

The progress indication bar 156 indicates the progress of parking assistance. The progress indication bar 156 includes a region containing the word “Setting” indicating that the target parking position 92 (see FIG. 3) is being set, a region containing the word “Assisting” indicating that automatic steering is being executed, and a region containing the word “End” indicating that parking assistance has ended. The region corresponding to the control being executed at that time among these regions is highlighted (for example, displayed in a different color) as compared with the other regions.

The operation guidance message 158 notifies the driver of the movement to be performed by the vehicle 12. In the example in FIG. 4, a message stating “Select [Start] to park in green frame” is displayed to notify that automatic steering is started by selecting one of the automatic steering start buttons 140a and 140b. The “green frame” here shows a candidate position image 168 displayed in the bird's-eye image region 152.

The parking type selection tabs 160a and 160b are used to select backward parking (perpendicular parking) or parallel parking as the parking type. Each of the parking type selection tabs 160a and 160b includes the two automatic steering start buttons 140a and 140b. Both the parking type selection tabs 160a and 160b and the automatic steering start buttons 140a and 140b are in selectable state (active state).

In the bird's-eye image region 152 in FIG. 4, the candidate position image 168 is displayed on each of the left and right sides of the host vehicle image 182 in addition to the host vehicle image 182 (indicating a display image simulating the actual vehicle 12) and a first provisional guide line 184a. The candidate position images 168 indicate candidate positions that are candidates for the target parking position 92. When the user selects the automatic steering start button 140a on the left side, the candidate position corresponding to the candidate position image 168 on the left side is set as the target parking position 92 and automatic steering starts. Alternatively, when the user selects the automatic steering start button 140b on the right side, the candidate position corresponding to the candidate position image 168 on the right side is set as the target parking position 92 and automatic steering starts.

FIG. 5 shows an example of the second display screen 144B when the vehicle 12 is moving forward in the target position setting process. The second display screen 144B contains the front image region 146 in addition to the attention attracting message 150, the bird's-eye image region 152, the parking assistance mark 154, the progress indication bar 156, the operation guidance message 158, the parking type selection tabs 160a and 160b, and the abort button 164, as the first display screen 144A (see FIG. 4).

For example, a message stating “Set green frame in parking position” is used as the operation guidance message 158 when the vehicle 12 is moving forward.

Although each of the parking type selection tabs 160a and 160b contains the start buttons 140a and 140b in FIG. 4, each of the parking type selection tabs 160a and 160b contains the front image region 146 for displaying the front image in FIG. 5.

The front image region 146 contains a prediction guide line 186 in addition to the first provisional guide line 184a. The prediction guide line 186 is formed by a line indicating a movement path of the vehicle 12 and colored in orange in the embodiment. The display range of the bird's-eye image region 152 in FIG. 5 is the same as the display range of the bird's-eye image region 152 in FIG. 4.

When the driver stops the vehicle 12 by depressing the brake pedal while the second display screen 144B in FIG. 5 is displayed, the parking assistance ECU 20 returns the display screen to the first display screen 144A (see FIG. 4).

When the vehicle 12 moves rearward (the shift position is set to R) while the first display screen 144A in FIG. 4 is displayed, the parking assistance ECU 20 performs switching to the third display screen 144C (see FIG. 6) used to move the vehicle 12 rearward during the target parking position setting control.

FIG. 6 shows an example of the third display screen 144C when the vehicle 12 is moving rearward in the target parking position setting control. The third display screen 144C contains the rear image region 148 in addition to the attention attracting message 150, the bird's-eye image region 152, the parking assistance mark 154, the progress indication bar 156, the operation guidance message 158, the parking type selection tabs 160a and 160b, and the abort button 164, as the first display screen 144A (see FIG. 4).

For example, a message stating “Set shift lever to D” is used as the operation guidance message 158 when the vehicle 12 is moving rearward. This is because automatic steering control in the embodiment is started on condition that the shift position is D (drive). In other words, the automatic steering start buttons 140a and 140b are not displayed unless the shift position is D.

In the first display screen 144A in FIG. 4, each of the parking type selection tabs 160a and 160b contains the automatic steering start buttons 140a and 140b. In contrast, in FIG. 6, each of the parking type selection tabs 160a and 160b contains the rear image region 148 for displaying a rear image as a movement direction image.

The rear image region 148 contains a second provisional guide line 184b. The second provisional guide line 184b is formed by lines displayed in the movement direction of the vehicle 12 or the host vehicle image 182 and colored in yellow in the embodiment. The second provisional guide line 184b is used when the vehicle 12 is moving rearward and has the same width as the first provisional guide line 184a. In addition, in the bird's-eye image region 152 in FIG. 6, the second provisional guide line 184b and the candidate position images 168 are indicated.

When the driver stops the vehicle 12 by depressing the brake pedal while the third display screen 144C in FIG. 6 is displayed and then changes the shift position to D (or other than R), the parking assistance ECU 20 returns the display screen to the first display screen 144A (see FIG. 4).

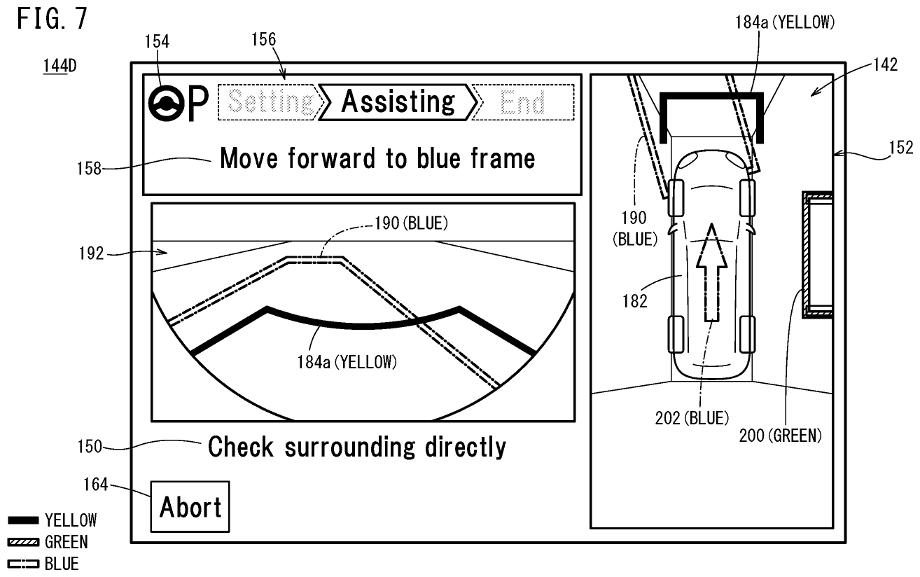

As described above, when the automatic steering start buttons 140a and 140b (see FIG. 4) are pressed, automatic steering control starts. At this time, a fourth display screen 144D (see FIG. 7) containing a movement direction image region 192 and the bird's-eye image 142 is displayed.

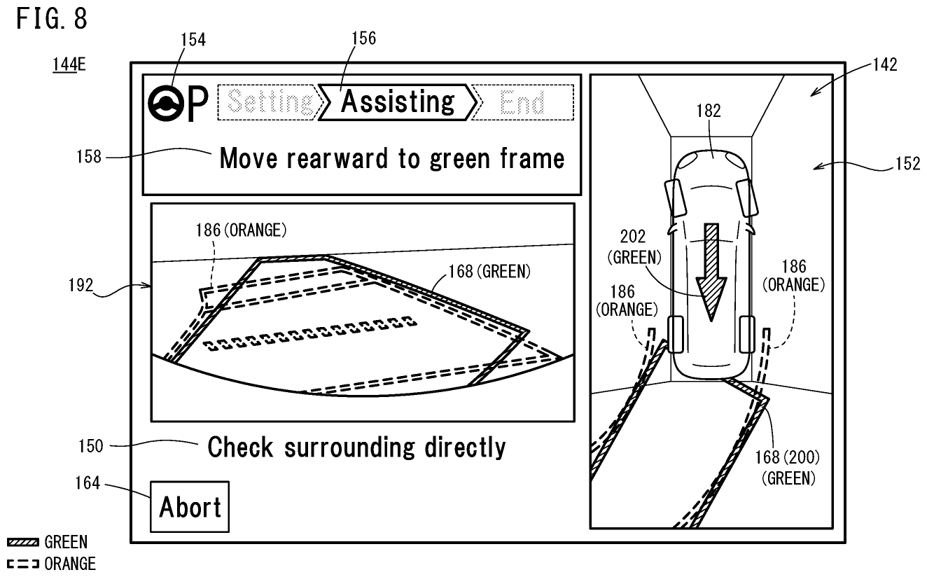

In automatic steering control, the display format is switched depending on whether the vehicle 12 is stopped or moving forward or the vehicle 12 is moving rearward. Specifically, when the vehicle 12 is stopped or moving forward, the parking assistance ECU 20 displays the fourth display screen 144D (see FIG. 7) containing the movement direction image region 192 and the bird's-eye image 142. Alternatively, when the vehicle 12 is moving rearward, the parking assistance ECU 20 displays a fifth display screen 144E containing the movement direction image region 192 and the bird's-eye image 142 as shown in FIG. 8.

When, for example, the shift position is other than R, it is decided that the vehicle 12 is stopped or moving forward. When, for example, the shift position is R, it is decided that the vehicle 12 is moving rearward.

When one of the automatic steering start buttons 140a and 140b is pressed or selected by the user on the first display screen 144A (see FIG. 4), the parking assistance ECU 20 performs switching to the fourth display screen 144D (see FIG. 7) used when the vehicle 12 is stopped or moving forward during automatic steering control.

The fourth display screen 144D in FIG. 7 is an example of the screen displayed when the vehicle 12 is moving forward toward a target turnabout position image 190 indicating the target turnabout position.

The fourth display screen 144D contains the movement direction image region 192 in addition to the attention attracting message 150, the bird's-eye image region 152, the parking assistance mark 154, the progress indication bar 156, the operation guidance message 158, and the abort button 164, as the first display screen 144A shown in FIG. 4.

When automatic steering control is entered, the parking assistance mark 154 becomes active and the word “Assisting” is highlighted in the progress indication bar 156. For example, a message stating “Move forward to blue frame” is used as the operation guidance message 158 displayed when the vehicle 12 is stopped or moving forward in automatic steering control. The “blue frame” here shows the target turnabout position image 190 contained in the bird's-eye image region 152.

The movement direction image region 192 displays the surrounding image present in the movement direction of the vehicle 12. That is, the movement direction image region 192 displays the front image when the vehicle 12 is stopped or moving forward (or the shift position is other than R) or displays the rear image when the vehicle 12 is moving rearward (or the shift position is R). In addition, as shown in FIG. 7, the movement direction image region 192 displays the target turnabout position image 190 in addition to the first provisional guide line 184a. The target turnabout position image 190 is formed by a line indicating the target turnabout position and colored in blue in the embodiment.

The fourth display screen 144D does not contain the parking type selection tabs 160a and 160b (see FIG. 4). Therefore, the vertical length of the display region of the movement direction image region 192 in FIG. 7 is larger than the vertical length of the display regions of the front image region 146 in FIG. 5 and the rear image region 148 in FIG. 6.

In addition, the bird's-eye image region 152 in FIG. 7 indicates the first provisional guide line 184a, the target turnabout position image 190, a target parking position image 200, and a movement direction image 202. The target parking position image 200 is a rectangular image indicating the target parking position 92 set by target parking position setting control and colored in green as the candidate position images 168 (see FIG. 6 and the like), in the embodiment.

The movement direction image 202 is an arrow-shape image indicating the movement direction of the vehicle 12 (host vehicle image 182) and displayed in the same color as the target stop position (that is, the target turnabout position or the target parking position) at that time in the embodiment. For example, when the vehicle 12 is moving forward toward the target turnabout position in the example in FIG. 7, the movement direction image 202 is displayed in blue as the target turnabout position image 190. Alternatively, when the vehicle 12 is moving rearward toward the target parking position, the movement direction image 202 is displayed in green as the target parking position image 200 (see FIG. 8).

When the shift position becomes R and the vehicle 12 starts moving rearward in automatic steering control, the parking assistance ECU 20 performs switching to the fifth display screen 144E (see FIG. 8) used when the vehicle 12 is moving rearward in automatic steering control.

FIG. 8 shows an example of the fifth display screen 144E when the vehicle 12 is moving rearward in automatic steering control. The fifth display screen 144E in FIG. 8 is an example of the screen when the vehicle 12 is moving rearward toward the target parking position image 200 indicating the target parking position 92.

The fifth display screen 144E contains the attention attracting message 150, the bird's-eye image region 152, the parking assistance mark 154, the progress indication bar 156, the operation guidance message 158, the abort button 164, and the movement direction image region 192, as the fourth display screen 144D described above.

For example, a message stating “Move rearward to green frame” is used as the operation guidance message 158 when the vehicle 12 is moving rearward. The “green frame” here shows the target parking position image 200 contained in the bird's-eye image region 152. The horizontal length and the vertical length of the bird's-eye image region 152 in FIG. 8 are the same as those of the bird's-eye image region 152 in FIG. 7.

Then, when at least the automatic steering control unit 82 of the vehicle control unit 76 is operating, the display control unit 70 changes the display range of the surrounding image displayed in the bird's-eye image region 152 based on at least the information of the vehicle speed V from the vehicle speed sensor 36 and the decision result (forward movement or rearward movement) by the operation decision unit 74. Of course, the display range of the surrounding image may be changed by taking the steering operation by the user (steering information from the EPS system 22) into consideration.

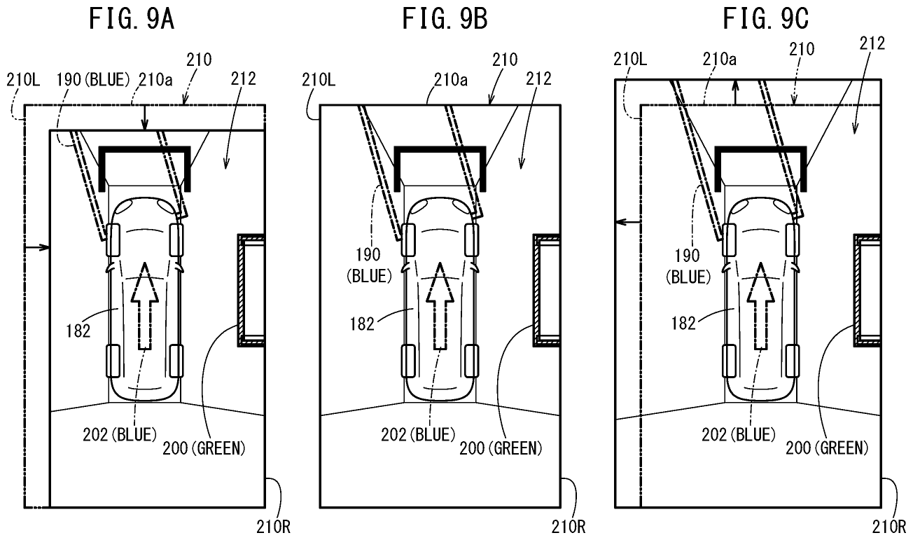

Here, several methods for changing the display range of the surrounding image displayed in the bird's-eye image region 152 will be described with reference to FIGS. 9A to 13C.

### First Method

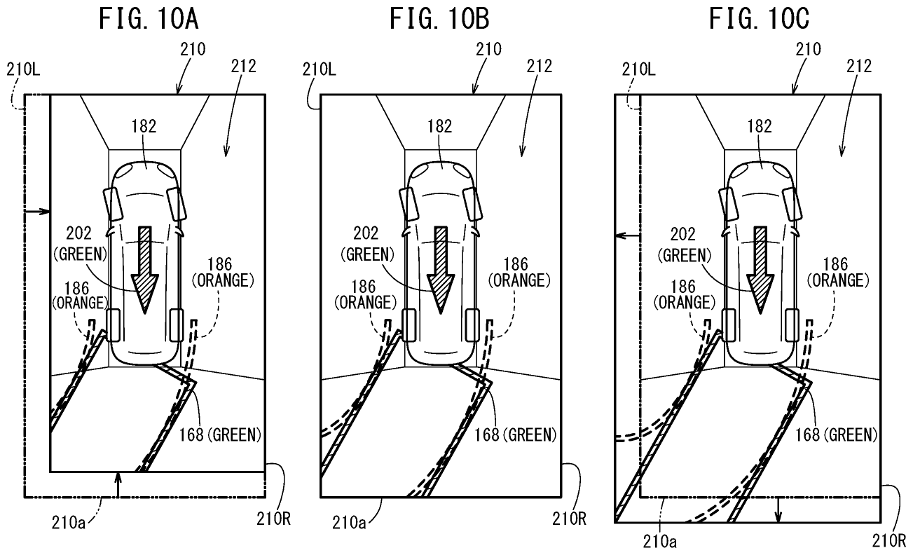

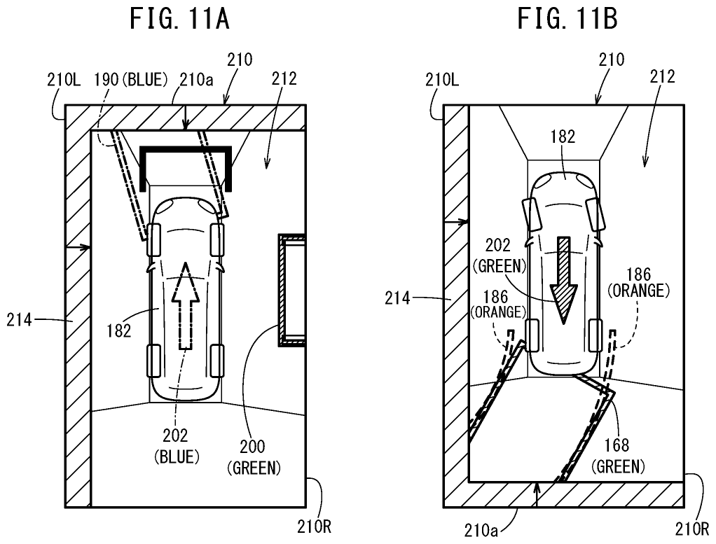

The first method will be described with reference to FIGS. 9A to 11B. FIGS. 9A to 9C and FIG. 11A indicate the case in which the host vehicle image 182 is moving forward and FIGS. 10A to 10C and FIG. 11B indicates the case in which the host vehicle image 182 is moving rearward.

First, when the vehicle speed V falls below a preset range (for example, V<5 km/h), for example, the size of a display frame 210 of a surrounding image 212 is made smaller than a standard size (see FIGS. 9B and 10B) as shown in FIGS. 9A and 10A. For example, a display frame (210a) of the display frame 210 present in the movement direction of the host vehicle image 182 is moved toward the host vehicle image 182 to reduce the display region of the surrounding image 212 present in the movement direction of the host vehicle image 182. FIG. 9A shows the change of the display frame 210 when the host vehicle image 182 is moving forward and FIG. 10A shows the change of the display frame 210 when the host vehicle image 182 is moving rearward. At this time, as shown in FIGS. 9A and 10A, when the steering direction by the user is left, a display frame 210L on the left side of the host vehicle image 182 is moved toward the host vehicle image 182. Although not shown, when the steering direction by the user is right, a display frame 210R on the right side of the host vehicle image 182 may be moved toward the host vehicle image 182. At this time, the movement speed of the display frame 210 may be changed according to the steering angle.

When the display frame 210 of the surrounding image 212 is made smaller, the display frame 210 itself may be moved as described above. Alternatively, as shown in FIGS.

11A and 11B, a colored mask 214 (blinder) may be displayed in the region to be made smaller with the size of the display frame 210 kept constant. This is true in the following examples.

When the vehicle speed V falls within the preset range (for example, 5 km/h≤V≤10 km/h), for example, the size of the display frame 210 of the surrounding image 212 is set to the standard size as shown in FIGS. 9B and 10B. This makes the display region of the surrounding image 212 in the movement direction of the host vehicle image 182 larger than in a lower speed.

When the vehicle speed V exceeds the preset range (for example, V>10 km/h), for example, the size of the display frame 210 of the surrounding image 212 is made larger than the standard size (see FIGS. 9B and 10B) as shown in FIGS. 9C and 10C. For example, the display frame (210a) of the display frame 210 present in the movement direction of the host vehicle image 182 is moved from the host vehicle image 182 to enlarge the display region of the surrounding image 212 present in the movement direction of the host vehicle image 182. FIG. 9C shows the change of the display frame 210 when the host vehicle image 182 is moving forward and FIG. 10C shows the change of the display frame 210 when the host vehicle image 182 is moving rearward. At this time, the display frame 210L on the left side of the host vehicle image 182 may be moved from the host vehicle image 182 when the steering direction by the user is left, or the display frame 210R on the right side of the host vehicle image 182 may be moved from the host vehicle image 182 when the steering direction by the user is right. At this time, the movement speed of the display frame 210 may be changed according to the steering angle. For example, as the steering angle is larger, the movement speed of the display frame 210 may become larger.

### Second Method

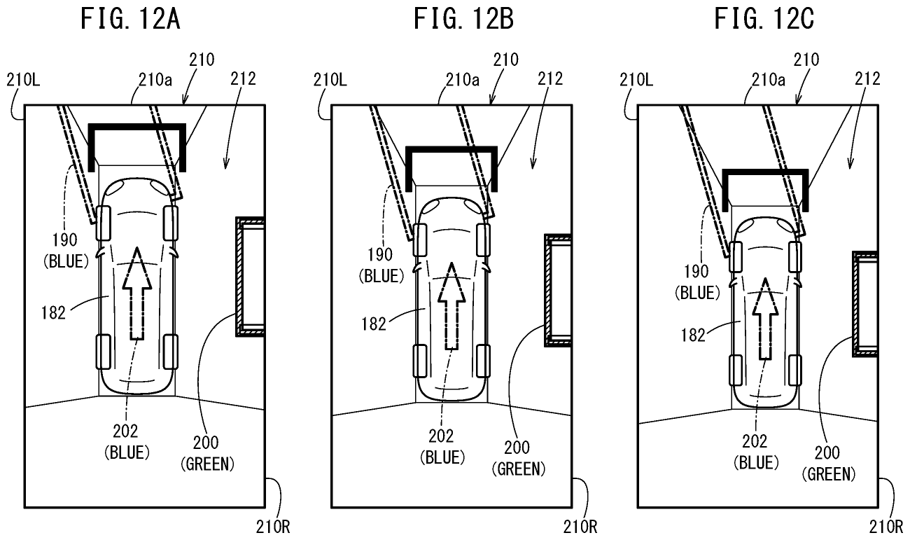

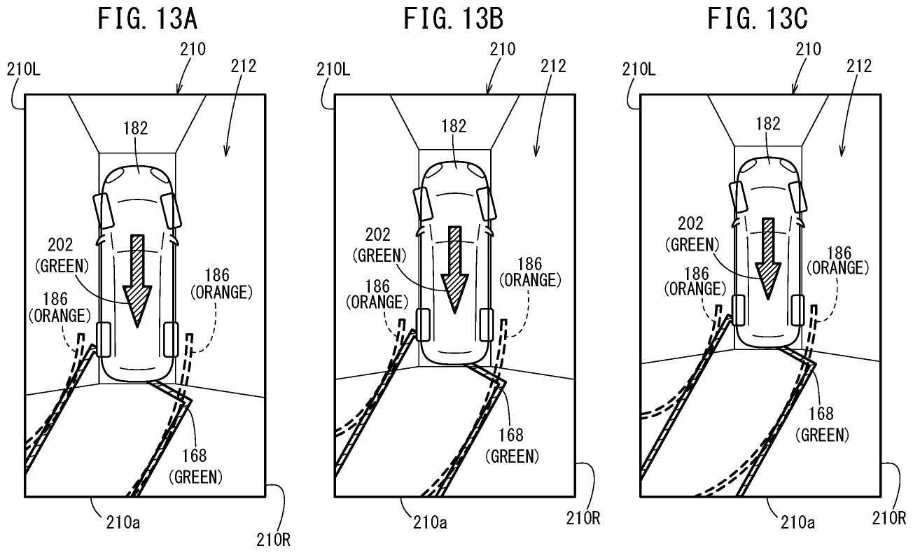

Specifically, when the vehicle speed V falls below a preset range (for example, a lower speed less than 5 km/h), for example, with the range of the display frame 210 of the surrounding image 212 shown in FIGS. 12B and 13B set to the standard size, the display region of the surrounding image 212 present in the movement direction of the host vehicle image 182 is made smaller by enlarging and displaying the surrounding image 212 including the host vehicle image 182 as shown in FIGS. 12A and 13A (enlarging and displaying the image data recorded in the image memory). In addition, when the steering direction by the user is left as in the first method, the display frame 210L on left side of the host vehicle image 182 may be moved toward the vehicle image. When the steering direction by the user is right, the display frame 210R on the right side of the host vehicle image 182 may be moved toward the host vehicle image 182.

When the vehicle speed V falls within the preset range (for example, 5 km/h≤V≤10 km/h), for example, with the range of the display frame 210 of the surrounding image 212 set to the standard size as shown in FIGS. 12B and 13B, the surrounding image 212 of the host vehicle image 182 is displayed at the same magnification (the image data recorded in the image memory is not enlarged or reduced).

When the vehicle speed V exceeds the preset range (for example, more than 10 km/h), for example, with the range of the display frame 210 of the surrounding image 212 shown in FIGS. 12B and 13B set to the standard size, the display region of the surrounding image 212 present in the movement direction of the host vehicle image 182 is enlarged by reducing and displaying the surrounding image 212 including the host vehicle image 182 as shown in FIGS. 12C and 13C (reducing and displaying the image data recorded in the image memory). FIG. 12C shows the change of the scale of the surrounding image 212 when the host vehicle image 182 is moving forward and FIG. 13C shows the change of the scale of the surrounding image 212 when the host vehicle image 182 is moving rearward. At this time, when the steering direction by the user is left, the display range of the surrounding image on the left side may be enlarged by moving the display frame 210L on the left side of the host vehicle image 182 from the vehicle image. When the steering direction by the user is right, the display range of the surrounding image on the right side may be enlarged by moving the display frame 210R on the right side of the host vehicle image 182 from the vehicle image.

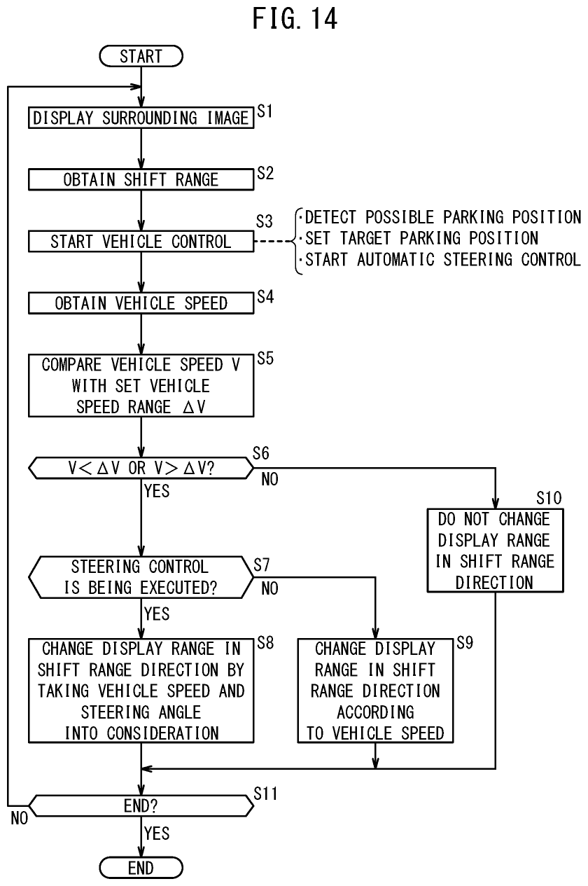

Next, the process operation of the parking assistance apparatus 10 according to the embodiment will be described with reference to FIG. 14.

First, in step S1 in FIG. 14, the display control unit 70 displays, on the touch panel 42 of the navigation apparatus 18 disposed in the vehicle 12, the taken image (that is, the surrounding image 212) obtained by the imaging unit (cameras 30a to 30d) for imaging at least the surrounding of the vehicle 12.

In step S2, the display control unit 70 obtains the operation (shift range) performed by the user with the operation input unit 14 from the operation detection unit 38 and the operation decision unit 74.

In step S3, the vehicle control unit 76 starts vehicle control based on an operation input from the user. That is, the target setting control unit 80 of the vehicle control unit 76 detects the possible parking position 90 and sets the target parking position 92 based on the operation input from the user. After that, the automatic steering control unit 82 of the vehicle control unit 76 starts automatic steering control based on, for example, an operation of the automatic steering start button 140a or 140b by the user. At this time, hazard lamp illumination or other operation is performed.

In step S4, the display control unit 70 obtains the vehicle speed V from the vehicle speed sensor 36.

In steps S5 and S6, the display control unit 70 compares the obtained vehicle speed V with a preset range (set vehicle speed range ΔV). When the vehicle speed V falls below the set vehicle speed range ΔV or the vehicle speed V exceeds the set vehicle speed range ΔV, the display control unit 70 proceeds to step S7 and detects whether steering control is being executed based on information from the steering angle sensor 100. When steering control is being executed, the display control unit 70 proceeds to step S8 and changes the display range of the bird's-eye image 142 present in the shift range direction (forward movement or rearward movement) by taking the vehicle speed V and the steering angle θst into consideration (see FIGS. 9A to 13C).

When steering control is not being executed, the display control unit 70 proceeds to step S9 and changes the display range of the bird's-eye image 142 present in the shift range direction (forward movement or rearward movement) according to the vehicle speed V.

In steps S8 and S9 described above, the shape, the color, and the like of the display frame 210 (inner frame) are changed at the same time. The display frame 210 before being enlarged is displayed in black, green, blue, or the like because the vehicle speed V is small. The display frame 210 having been enlarged can be displayed in a color (such as, for example, red) indicating that the vehicle speed V is large and the display range is large to attract attention.

In contrast, when it is decided that the vehicle speed V falls within the set vehicle speed range ΔV in steps S5 and S6, the display control unit 70 proceeds to step S10 and does not change the display range present in the shift range direction.

When the processing in step S8, the processing in step S9, or the processing in step S10 ends, the display control unit 70 proceeds to step S11 and decides whether an end request (such as power interruption or maintenance) of the parking assistance apparatus 10 is present.

When the end request is not present, the display control unit 70 repeats the processing in step S1 and subsequent steps. When the end request is present, the display control unit 70 ends the processing by the display control unit 70.

### Technical Concept Obtained from the Embodiment

The technical concept that can be grasped from the above embodiment will be described below.

The parking assistance apparatus 10 according to the embodiment displays, on the display unit (touch panel 42 of the navigation apparatus 18) disposed in the host vehicle 12, the taken image obtained by the imaging unit (cameras 30a, 30b, 30c, and 30d) that images the surrounding of the host vehicle 12, and includes the unit (vehicle speed sensor 36) configured to detect the speed (vehicle speed V) of the host vehicle 12 and the display control unit 70 configured to display the surrounding image 212 obtained by the imaging unit on the display unit, wherein the display control unit 70 is configured to change the display range of the surrounding image 212 based on at least the detected speed (vehicle speed V) of the host vehicle 12.

Since this changes the display range of the surrounding image 212 based on at least the detected speed of the host vehicle 12, surrounding monitoring by the occupant can be improved during parking assistance.

The parking assistance apparatus 10 according to the embodiment further includes the vehicle control unit 76 configured to park the host vehicle 12 in a possible parking region and the display control unit 70 links the display range to the vehicle speed from the start of vehicle control by the vehicle control unit 76.

Since the display control unit 70 links the display range to the vehicle speed from the start of vehicle control by the vehicle control unit 76, an appropriate range according to the speed of the host vehicle 12 is displayed in surrounding monitoring by the occupant during parking assistance. As a result, visibility for surrounding monitoring by the occupant can be improved.

In the embodiment, the display control unit 70 enlarges the display range when the vehicle speed V becomes a predetermined speed or more.

When the vehicle speed V becomes higher, the distance per unit time moved by the host vehicle 12 becomes longer. When the display range is constant at this time, the occupant needs to perform surrounding monitoring frequently, which is bothersome. Accordingly, by enlarging the display range when the vehicle speed V becomes the predetermined speed or more, an obstacle or the like can be easily grasped in advance and visibility is further improved.

In the embodiment, the display control unit 70 is configured to enlarge the display range in a stepwise manner. By enlarging the display range in a stepwise manner when the vehicle speed V becomes the predetermined speed or more, an obstacle or the like can be easily grasped in advance and visibility is further improved.

When the display range is linked to the vehicle speed in the embodiment, the shape or color of the inner frame (display frame 210) within the display range is changed. The display frame 210 before being enlarged is displayed in black, green, blue, or the like because the vehicle speed V is small. The display frame 210 having been enlarged can be displayed in a color (such as, for example, red) indicating that the vehicle speed V is large and the display range is large to attract attention. That is, more intuitive information for surrounding monitoring can be provided for the occupant.

In the embodiment, the display control unit 70 makes the display range when the vehicle control (at least steering control) operates different from the display range when the vehicle control does not operate.

To make the display range when the vehicle control operates different from the display range when the vehicle control does not operate, in the case of, for example, steering control, the display range is changed according to the steering direction as the steering angle Est increases. By changing the display range according to the steering direction, the visuality in the movement direction of the host vehicle 12 is improved and appropriate surrounding monitoring can be expected.

In the embodiment, the display control unit 70 is configured to enlarge the display range of the surrounding image 212 present at least in the shift range direction (forward movement or rearward movement) of the host vehicle 12. By enlarging the display range present in the movement direction, surrounding monitoring by the occupant can be further improved.

In the embodiment, the display control unit 70 is configured to generate the bird's-eye image 142 that looks down on the host vehicle 12 based on the surrounding image 212 and display the generated bird's-eye image 142 on the display unit. By generating the bird's-eye image 142 that looks down on the host vehicle 12 and displaying the generated bird's-eye image 142, a surrounding obstacle and the like can be easily grasped and visibility for surrounding monitoring can be improved.

The vehicle (host vehicle 12) according to the embodiment includes the parking assistance apparatus 10 according to the embodiment described above.

The parking assistance method according to the embodiment outputs, to the display unit disposed in the host vehicle 12, the taken image obtained by the imaging unit that images the surrounding of the host vehicle 12, and includes a step of detecting the speed of the host vehicle 12 and a display control step of displaying the surrounding image 212 obtained by the imaging unit on the display unit, wherein the display control step changes the display range of the surrounding image 212 based on at least the detected speed of the host vehicle 12.

A non-transitory computer readable recording medium according to the embodiment stores a program for executing in a computer: a step of outputting, to the display unit disposed in the host vehicle 12, the taken image obtained by the imaging unit that images the surrounding of the host vehicle 12; a step of detecting the speed of the host vehicle 12; a step of displaying the surrounding image 212 obtained by the imaging unit on the display unit; and a step of changing the display range of the surrounding image 212 based on at least the detected speed of the host vehicle 12.

Although a preferable embodiment of the present invention has been described above, the present invention is not limited to the above embodiment and various modifications can be made without departing from the gist of the present invention.

What is claimed is:

1. A parking assistance apparatus that displays, on a display unit disposed in a host vehicle, a taken image obtained by an imaging unit that images a surrounding of the host vehicle, the parking assistance apparatus comprising:
a unit configured to detect a speed of the host vehicle; and
a display control unit configured to display a surrounding image obtained by the imaging unit on the display unit,
wherein the display control unit is configured to change a display range of the surrounding image based on at least the detected speed of the host vehicle.

2. The parking assistance apparatus according to claim 1, further comprising a vehicle control unit configured to park the host vehicle in a possible parking region,
wherein the display control unit changes the display range according to the detected speed of the host vehicle from start of vehicle control by the vehicle control unit.

3. The parking assistance apparatus according to claim 2, wherein
the display control unit enlarges the display range when the speed becomes a predetermined speed or more.

4. The parking assistance apparatus according to claim 3, wherein the display control unit is configured to enlarge the display range in a stepwise manner.

5. The parking assistance apparatus according to claim 2, wherein when the display range is changed according to the detected speed of the host vehicle, a shape or a color of an inner frame within the display range is changed.

6. The parking assistance apparatus according to claim 2, wherein the display control unit makes the display range when the vehicle control operates different from the display range when the vehicle control does not operate.

7. The parking assistance apparatus according to claim 1, wherein the display control unit is configured to enlarge the display range of the surrounding image present at least in a shift range direction of the host vehicle.

8. The parking assistance apparatus according to claim 1, wherein the display control unit is configured to generate a bird's-eye image that looks down on the host vehicle based on the surrounding image and display the bird's-eye image on the display unit.

9. A vehicle comprising the parking assistance apparatus according to claim 1.

10. A parking assistance method that outputs, to a display unit disposed in a host vehicle, a taken image obtained by an imaging unit that images a surrounding of the host vehicle, the parking assistance method comprising:
a step of detecting a speed of the host vehicle; and
a display control step of displaying a surrounding image obtained by the imaging unit on the display unit, wherein
the display control step changes a display range of the surrounding image based on at least the detected speed of the host vehicle.

11. A non-transitory computer readable recording medium in which a program is stored for executing in a computer:
a step of outputting, to a display unit disposed in a host vehicle, a taken image obtained by an imaging unit that images a surrounding of the host vehicle;
a step of detecting a speed of the host vehicle;
a step of displaying a surrounding image obtained by the imaging unit on the display unit; and
a step of changing a display range of the surrounding image based on at least the detected speed of the host vehicle.
